(19) United States
(12) Patent Application Publication
(10) Pub. No.: US 2004/0069153 A1
(43) Pub. Date: Apr. 15, 2004

(54) Apparatus and method for producing cereal cakes

(76) Inventor: Gordon MacDonald Bodie Smith, Huddersfield (GB)

Correspondence Address: FULBRIGHT & JAWORSKI, LLP, 1301 MCKINNEY, SUITE 5100, HOUSTON, TX, 77010-3095, US

(21) Appl. No.: 10/250,337

(22) PCT Filed: Dec. 19, 2001
(86) PCT No.: PCT/GB01/05652

(30) Foreign Application Priority Data
Jan. 2, 2001 (GB) 0100042.1

(51) Int. Cl. A23L 1/00

(52) U.S. Cl. 99/349

(57) ABSTRACT

An apparatus for producing cereal cakes or the like by a process of heating and expanding, comprising: a rotatable heatable platten 102 defining a plurality of moulds 104, a plurality of displaceable moulding tools 106, 108 for communicating with the platten, wherein as the platten is rotated, successive moulds are heated and closed by the moulding tools to produce a continuous supply of cereal cakes. The invention provides for the continuous production of granular cereal crackers or cakes. It has the advantage of improved yield per unit time, and thus reduced cost per unit.

This invention relates to an apparatus and method for producing foodstuffs, such as crackers or cakes. More specifically, this invention relates to apparatus for continuously producing granular crackers or cakes from cereal or other such materials.

There exist various apparatus for producing granular crackers from cereal raw materials. Some of these utilise the processes of pressure baking and expanding the materials to produce crackers or the like. The crackers produced come in various shapes and sizes, are made from different cereals/raw materials and different combinations of cereals and/or other raw materials, and are intended for different purposes. For example, rice crackers in the shape of a bone may be used for the feeding of dogs, whereas other shapes may be more intended for human consumption.

In the prior art apparatus, as may be readily seen in EP 0499301 (corresponding to WO 92/12646) and EP 0359740 (corresponding to WO 88/06425), moulds consisting of a stationary upper heated mould element, a moveable ring mould and a reciprocating lower mould element are utilised. These moulds may comprise a number of individual moulding areas. In operation, cereal product is placed upon the lower mould element, which is then raised into the ring mould. This action causes product to be contained within the chamber formed by the three mould elements. Inside this chamber, the product is subjected to pressure baking and expansion. To remove the product which is now in the form of an expanded cereal cracker, the lower mould element is lowered and the cracker is scraped or pushed off of it.

As will be readily appreciated, the above process is limited as to the number of pieces it can produce in a given time, because for each moulding step carried out, all the moulds must be emptied and refilled. It is a classic batch process wherein whilst filling etc. is taking place, moulding is not. This is obviously undesirable. The more pieces that can be produced in a given time, the better, from the point of view of both the manufacturer and consumer. This is because the more pieces that are produced per unit time, the less the cost per piece is to the manufacturer. Ultimately this benefit can be passed on to the consumer.

Therefore, there exists a problem in increasing the yield of granular cracker producing apparatus.

The present invention provides an apparatus with distinct advantages over the prior art. This apparatus does not operate a batch production procedure. Rather, it continuously produces pieces whilst it is in operation.

According to the present invention, there is provided an apparatus for producing cereal cakes or the like by a process of heating and expanding, comprising a rotatable heatable platten defining a plurality of moulds and a plurality of displaceable moulding tools for communicating with the platten, wherein as the platten is rotated successive moulds are heated and closed by the moulding tools to produce a continuous supply of cereal cakes.

According to a preferred embodiment of the present invention, the moulds in the platten take the form of bores running through the platten.

According to a preferred embodiment of the present invention, for each mould, there is a corresponding pair of moulding tools, the pair comprising, when the platten is arranged to rotate in a horizontal plane, a downwardly displaceable tool arranged to descend into the mould, and an upwardly displaceable tool arranged to ascend into the mould.

Preferably, the moulding tools, when located within the mould, sealingly form a chamber defined by the mould and the tools.

According to a further preferred embodiment of the present invention, the moulding tools are guided by a track or rail. Preferably, a first set of tools are guided by a first rail and a second set of tools are guided by a second rail. More preferably, the first rail is adjacent one face of the platten and the second rail is adjacent the other face of the platten.

According to a further preferred embodiment of the present invention, the guide rails are configured to effect the displacement of the tools associated therewith, with respect to the rotatable platten, as the platten rotates.

According to a further preferred embodiment of the present invention, each rail comprises at least two phases, each phase positioning a tool attached to the rail at a selected displacement with respect to the rotatable platten. Preferably, the tools in communication with one guide rail go through periods of being completely removed from their corresponding moulds and other periods of being positioned partially therein. Preferably, the tools attached to one guide rail move through various amounts of partial containment within mould, as dictated by the position of the guide rail in relation to the platten in the various phases.

According to a still further preferred embodiment of the present invention, displacement of the moulding tools occurs due to undulations in the guide track. Preferably, the moulding tools move with the rotating platten, in such a way that the tools retain their locations relative to the mould space to which they correspond.

Also, in accordance with the present invention there is provided a method of continuously producing cereal cakes or the like, comprising the steps of, for each mould in a plurality of moulds arranged to cycle repeatedly through a closed loop, filling the mould with cereal or the like, closing the mould, heating the mould for a period, and opening the mould and dispensing a cake. Preferably, the method further includes the step of pre-heating the mould during the closure thereof.

Preferably, each step is carried out in accordance with the location of a mould within the cycle.

A specific embodiment of the present invention is now described, by way of example only, with reference to the accompanying drawings, in which:

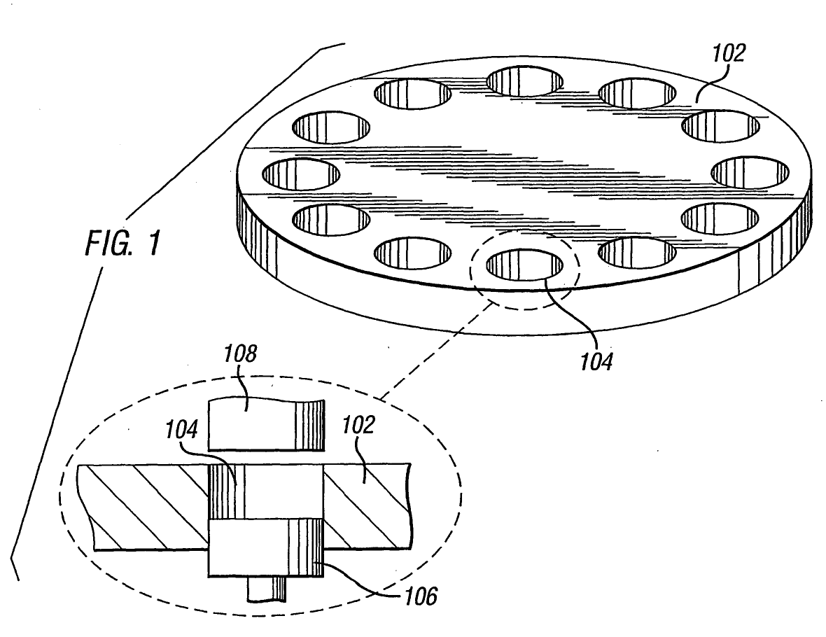

FIG. 1 shows a platten for use in the present invention;

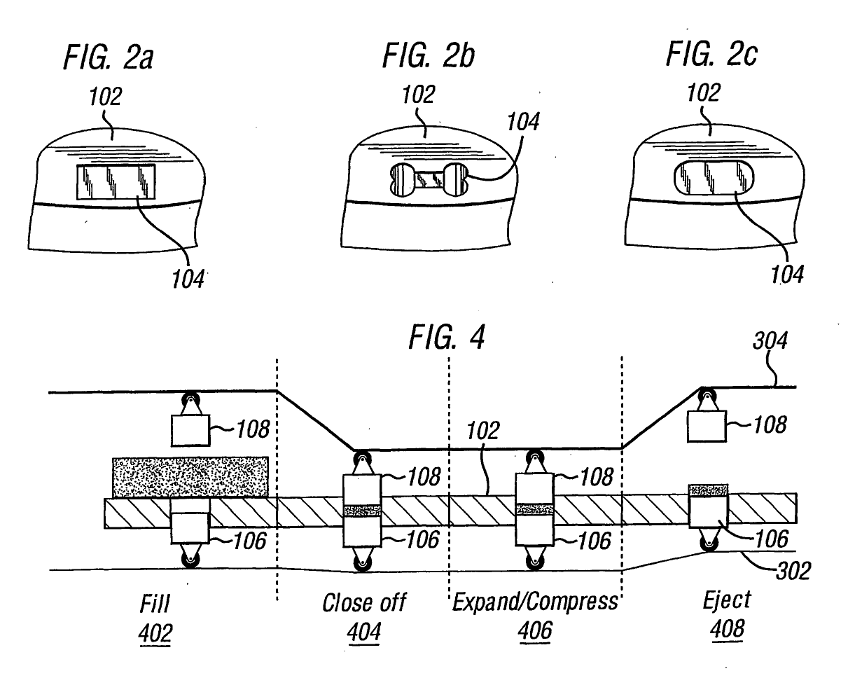

FIG. 2a shows a square mould configuration;

FIG. 2b shows a dog's bone shaped mould configuration;

FIG. 2c shows an oval mould configuration;

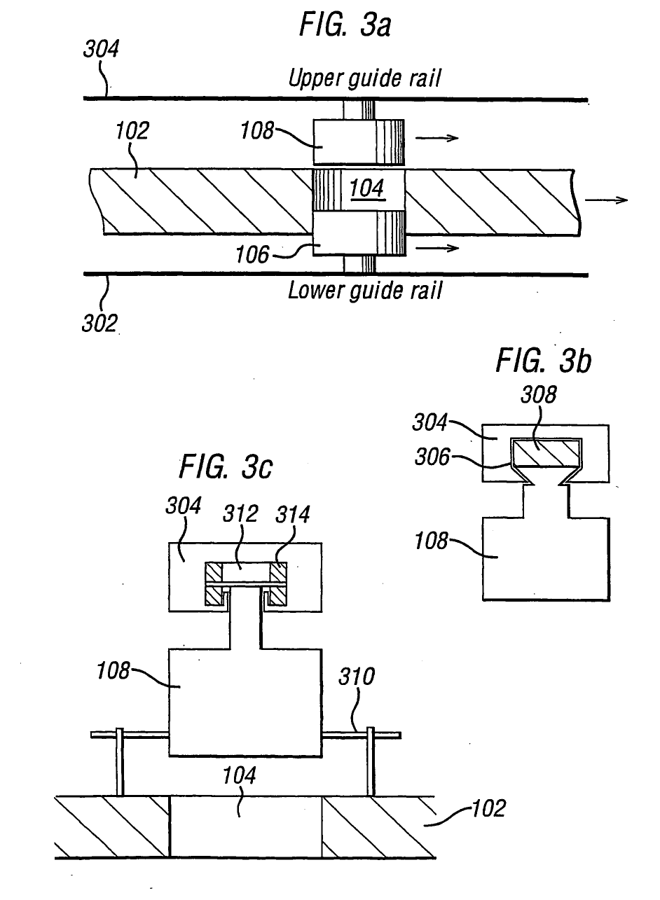

FIGS. 3a-c illustrate the operation and possible configurations of guide tracks according to the present invention; and

FIG. 4 illustrates the operation of the apparatus of the above three Figures.

Referring to the drawings, and firstly to FIG. 1, the apparatus makes use of a rotatable platten 102. The platten is generally located in the horizontal plane, and has located around, and inwardly spaced from, its outer most edge, a plurality of apertures 104 bored through it. These apertures form the first part of a three-part mould system according to this invention. Rotation of the platten is provided by an electric motor (not shown), or other such means.

As may be seen from FIGS. 2a-c, the moulds may take any reasonable shape, thus allowing the production of shaped pieces or crackers. FIG. 2a illustrates a mould with a square configuration. FIG. 2b shows a mould with a dog's bone configuration and FIG. 2c shows a mould with a curved profile.

Returning to FIG. 1, for each aperture or mould 104 there is provided an. upper and lower moulding tool. These comprise the remaining two parts of the three part mould system mentioned above. As is illustrated, the lower moulding tool 106 is located within the mould 104. The lower moulding tool 106 is able to advance inwardly along the mould 104 and equally to retreat outwardly along the mould 104. The means, one or more pairs of guide tracks, by which this movement is effected will be described below. Whilst movement is provided to the lower moulding tool 106, it is prevented from exiting the mould 104. The lower moulding tool 106 remains at least partially within the mould 104 at all times, except perhaps for cleaning.

Corresponding to the lower moulding tool 106, there is provided an upper moulding tool 108. The upper moulding tool 108 is provided with similar movement to the lower moulding tool 106, except that it is enabled to be removed entirely from the mould 104 in order to facilitate the entry of material thereto.

In order for pressure baking of cereals to take place, those cereals must be pressurised when in the moulding space. Such pressurisation is provided by the expansion of the product between the two moulding tools whilst bound by the mould 104. However, in order that this is best achieved, there is provided a seal between each tool and the mould 104 in which it is located, and in the case of the upper tool, when it is located therein. This is to ensure that no product escapes from the mould, and likewise that no foreign body enters the mould during the process. To facilitate pressure baking, the platten is heated, thereby transferring heat to the cereal/raw materials located within the mould space 104, through the walls thereof. This results in very efficient heating of the cereal, saving processing time over prior art apparatus.

The configuration of the guide tracks is now described with reference to FIGS. 3a-c. As has already been stated, the guide tracks control the position of the moulding tools 106, 108 with respect to the rotatable platten 102. In other words, it is the guide tracks which control the displacement of the moulding tools 106, 108. As may be seen in FIG. 3a, as the platten 102 rotates, the moulding tools 106, 108 are caused to move in order to retain their relationship with the platten. It is the guide tracks 302, 304 which determine the paths which are followed by the tools, thus, in the case of FIG. 1 which provides a circular rotatable platten, the guide rails would present a circular profile located about the same axis as the platten with its diameter corresponding to the distance between the central axis of the platten and of the moulding spaces.

FIG. 3b illustrates one possible mechanism for providing movement to the tools. Each guide track 302, 304 is provided with a keyed groove in which there is provided a conveyor means 308, in the form of a belt or chain for example. Each tool is attached to the conveyor means 308. The movement of the conveyor means is synchronous with that of the platten. Thus, as the platten rotates, the conveyor means moves around the guide track carrying the moulding tools 106, 108 and maintaining their spatial arrangement with respect to the platten and the mould spaces to which they correspond.

FIG. 3c depicts an alternative mechanism for providing movement to the tools 106, 108. As was previously set forth, the lower moulding tool 106 remains at least partially within the mould space at all times. Therefore, the movement thereof is provided by the rotating platten as it rotates. In this case, the lower guide track 302 serves to maintain the correct alignment of the tool within the mould space, and to vary the degree of entry therein. The first of these may be achieved by a wheel arranged in the groove, or in other similar arrangement. The second will be discussed below.

The case for the upper moulding tool 108 is more complex, because the upper moulding tool is removed entirely from the moulding space 104 for at least a part of the production process (as will be described below with reference to FIG. 4). In order to utilise the movement of the platten 102 as the driving force, there is provided a guide means 310 arranged around each mould 104 on the upper surface of the platten 102. The guide means 310 is in contact with the tool at all times during production, thereby effectively transmitting the movement of the platten to the tool. The guide means 310 is arranged so that it remains in contact with the upper moulding tool 108 irrespective of the degree of entry, into the mould 104, of the tool. In order to facilitate this drive mechanism, the upper guide track is provided with means for allowing movement of the tool attached thereto. In this embodiment, such means take the form of an internal track 312 and enclosed wheel 314 arrangement as may best be seen in FIG. 3c.

The provision of displacement to the moulding tools 106, 108 is now described with reference to FIG. 4. As may be seen, the spacing of each guide track 302, 304 relative to the closest surface of the platten 102 differs according to the stage of the cracker production process currently being undertaken for a specific mould group 104, 106, 108. Referring firstly to the lower mould tool 106 and track 302, there are provided inclines in the track 302. These link raised and lowered portions of the track 302. As such, a tool 106 travelling along the lower guide track 302 will travel down an incline between a raised and a lower track section, thereby causing the tool 106 to be partially retracted from the mould 104. Similarly, when an incline between a lower track section and a raised track section is traversed, the tool 106 will penetrate further into the mould 104.

The displacement or reciprocation of the upper tool 108 follows the same principles. However, traversing an incline between a raised and lower track section induces penetration into the mould 104, and traversing an incline between a lowered track section and a raised track section induces removal of the moulding tool 108 from the mould 104, either partially or totally.

The cracker production process, utilising the apparatus of the present invention, is now described, again with reference to FIG. 4. The process comprises essentially four stages. Each mould group 104, 106, 108 progresses through all the stages and, upon completion, recommences. Therefore, one complete revolution of the platten 102 forms a cycle within a continuous process. The first stage 402 constitutes the filling of the mould with one or more granular cereal, such as rice, or other raw material. When a mould group progresses through this stage, it is configured by the guide tracks 302, 304 such that the upper moulding tool 108 is retracted entirely from the moulding space, thereby allowing the entry of cereal etc. thereto. The lower moulding tool 106 is located partially within the moulding space 104, thereby forming a recess for the reception of cereals.

The next stage 404 constitutes the closing of the mould group 104, 106, 108 to form a mould. As a mould group 104, 106, 108 passes through this stage, the upper guide track 304 is arranged such that the upper moulding tool 108 enters the mould 104, thereby forming the required mould shape. As this is taking place, the lower moulding tool 106 is caused by the lower guide track 302 to retract slightly. Additionally, the cereal product within the mould may be preheated by heating of the platten 102 during this closure. Such a procedure speeds up the overall process of cake production, because it reduces the duration of heating required when the mould is fully closed.

During the third stage 406 of the process, the spatial arrangement of the mould group 104, 106, 108 is not caused to vary. It is during this stage that the cereal contained within the mould is subjected to pressure baking by the heated platten and mould arrangement, and to expansion. More particularly, the rice grains expand to fill the mould cavity, and are subsequently pressurised into a defined shape by the mould. At the end of this stage, an expanded cereal cracker has been formed in the mould group 104, 106, 108.

The final stage 408 in the process is the ejection and/or removal of the produced cracker from the mould group 104, 106, 108 and indeed the whole apparatus. In this stage, the guide tracks are shaped such that, as a mould group 104, 106, 108 passes through, the upper moulding tool 108 is retracted entirely from the mould space 104. Additionally, the lower moulding tool 106 is caused to penetrate further into the mould 104, such that the cereal cracker produced is lifted out of the mould 104. In this position, the upper surface of the lower moulding tool 106 (in contact with the cracker) is substantially aligned with the upper surface of the platten 102. The formed cracker or cake is now removed from the platten by sweeping, scraping, or some other analogous procedure.

Whilst this invention has been described with reference to moulding tools which present a planar profile (see FIGS. 1 to 4) to the interior chamber of the mould. It will be readily appreciated that shaped profiles may be as easily utilised. For example, moulding tools presenting concave and/or convex surfaces to the mould interior are certainly suitable.

It will of course be understood that the present invention has been described above by way of example only and that modifications of detail can be made within the scope of this invention.

1. An apparatus for producing cereal cakes or the like by a process of heating and expanding, comprising:
a rotatable heatable platten defining a plurality of moulds; and
a plurality of displaceable moulding tools for communicating with the platten;
wherein as the platten is rotated, successive moulds are heated and closed by the moulding tools to produce a continuous supply of cereal cakes.

2. An apparatus as claimed in claim 1, wherein the moulds in the platten take the form of bores running through the platten.

3. An apparatus as claimed in claim 2, wherein, for each mould, there is a corresponding pair of moulding tools, the pair comprising, when the platten is arranged to rotate in a horizontal plane:
a downwardly displaceable tool arranged to descend into the mould; and
an upwardly displaceable tool arranged to ascend into the mould.

4. An apparatus as claimed in claim 3, wherein the moulding tools, when located within the mould, form a closed chamber defined by the mould and the tools.

5. An apparatus as claimed in any preceding claim, wherein the moulding tools are guided by a rail.

6. An apparatus as claimed in claim 5, wherein a first set of tools are guided by a first rail and a second set of tools are guided by a second rail.

7. An apparatus as claimed in claim 6, wherein the first rail is adjacent one face of the platten and the second rail is adjacent the other face of the platten.

8. An apparatus as claimed in claim 5, 6 or 7, wherein the guide rails are configured to effect the displacement of the tools associated therewith, with respect to the rotatable platten, as the platten rotates.

9. An apparatus as claimed in any of claims 5 to 8, wherein each rail comprises at least two phases, each phase positioning a tool attached to the rail at a selected displacement with respect to the rotatable platten.

10. An apparatus as claimed in claim 9, wherein the tools in communication with one guide rail go through periods of being completely removed from their corresponding moulds and other periods of being positioned partially therein.

11. An apparatus as claimed in claim 9 or claim 10, wherein the tools attached to one guide rail move through various amounts of partial containment within a mould, as dictated by the position of the guide rail in relation to the platten in the various phases.

12. An apparatus as claimed in any of claims 9 to 11, wherein displacement of the moulding tools occurs due to undulations in the guide track.

13. An apparatus as claimed in any preceding claim, wherein the moulding tools move with the rotating platten, in such a way that the tools retain their locations relative to the mould space to which they correspond.

14. An apparatus as claimed in any preceding claim, further comprising drive means for rotating the platten and/or the moulding tools.

15. A method, using an apparatus as claimed in any preceding claim, of continuously producing cereal cakes or the like, comprising the steps of:
for each mould in a plurality of moulds arranged to cycle repeatedly through a closed loop:
filling the mould with cereal or the like;
closing the mould;
heating the mould for a period; and
opening the mould and dispensing a cake.

16. A method as claimed in claim 15, wherein the mould is pre-heated during the closure thereof.

17. A method as claimed in either of claim 15 or 16, wherein each step is carried out in accordance with the location of a mould within the cycle.
